(19) United States
(12) Patent Application Publication
(10) Pub. No.: US 2024/0303003 A1
(43) Pub. Date: Sep. 12, 2024

(54) INFORMATION PROCESSING SYSTEM, NON-TRANSITORY COMPUTER READABLE MEDIUM, AND INFORMATION PROCESSING METHOD

(71) Applicant: FUJIFILM BUSINESS INNOVATION CORP., Tokyo (JP)

(72) Inventor: Misaki MATSUZAWA, Kanagawa (JP)

(73) Assignee: FUJIFILM BUSINESS INNOVATION CORP., Tokyo (JP)

(21) Appl. No.: 18/363,414

(22) Filed: Aug. 1, 2023

(30) Foreign Application Priority Data
Mar. 6, 2023 (JP) 2023-034077

(51) Int. Cl. G06F 3/12

(52) U.S. Cl. CPC G06F 3/1204; G06F 3/1241; G06F 3/1284; G06F 3/1285

(57) ABSTRACT

An information processing system includes a processor configured to: receive a job; divide the job into multiple job divisions; and for each job division, when the job division is set to be processed by using a local functionality processed in a local environment including the information processing system, cause the local environment to process the job division, and, when the job division is set to be processed by using a cloud functionality processed in a cloud environment which does not include the information processing system, cause the cloud environment to process the job division.

### CROSS-REFERENCE TO RELATED APPLICATIONS

This application is based on and claims priority under 35 USC 119 from Japanese Patent Application No. 2023-034077 filed Mar. 6, 2023.

### BACKGROUND

### (i) Technical Field

The present disclosure relates to an information processing system, a non-transitory computer readable medium, and an information processing method.

### (ii) Related Art

Japanese Unexamined Patent Application Publication No. 2000-353066 discloses an information processing apparatus which at least executes a job that needs an authentication process. The information processing apparatus includes a dividing unit, a first execution unit, and a second execution unit. The dividing unit divides a job into a first job and a second job. The first execution unit executes the first job before completion of an authentication process, and puts execution of the second job on hold. The second execution unit executes the second job when the authentication process completes.

Japanese Unexamined Patent Application Publication No. 2019-040327 discloses an information processing apparatus in an information processing system in which a first environment is connected to a second environment over a network. The information processing apparatus is included in either the first environment or the second environment. The information processing apparatus includes a workflow execution unit which executes a workflow, which is a series of processes, by using data received by the information processing apparatus. The information processing apparatus includes a workflow determination unit which determines in which environment, the first environment or the second environment, some or all of the processes are to be performed, on the basis of at least one of the following types of information: the data characteristics of data which is to be processed in the workflow; the processing characteristics of the processes included in the workflow; and the processing conditions of the processes.

Japanese Unexamined Patent Application Publication No. 2005-161819 discloses a printer which prints again print job data which is spooled in advance. The printer includes a reception unit which receives print job data from a host computer, and a dividing unit which divides the received print job data on a page-by-page basis. The printer includes a determination unit which determines, for each print job data division obtained by the dividing unit dividing the print job data into individual pages, whether the print job data division is to be spooled as page-description language (PDL) data without conversion or as raster data, on the basis of the types of objects included in the page. The printer includes a spooling unit which stores the PDL data, as it is, of the print job data division for a page determined to be spooled as PDL data without conversion, and which stores the corresponding raster data of the print job data division for a page determined to be spooled as raster data. The printer includes a conversion unit. On reception of an instruction to print again print job data, the conversion unit reads print job data, page by page, from the spooling unit. For each page, if the read print job data remains in PDL data, the conversion unit converts the PDL data into raster data. The printer includes a print output unit which prints and outputs raster data, which is read from the spooling unit, and raster data from the conversion unit in the order of the pages.

Assume that a job includes a job division, which is set to be processed by using a local functionality performed in a local environment including an information processing system, and a job division, which is set to be processed by using a cloud functionality performed in a cloud environment which does not include an information processing system. When such a job is processed in the local environment, the job division which is set to be processed by using a cloud functionality fails to be processed. When such a job is processed in the cloud environment, the job division which is set to be processed by using a local functionality fails to be processed. Thus, job divisions to which different functionalities are set have a problem that some job divisions remain unprocessed.

### SUMMARY

Aspects of non-limiting embodiments of the present disclosure relate to an information processing system, a non-transitory computer readable medium, and an information processing method which enable each job division to be processed even when a different functionality is set to the job division.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising: a processor configured to: receive a job; divide the job into a plurality of job divisions; and for each job division, when the job division is set to be processed by using a local functionality processed in a local environment including the information processing system, cause the local environment to process the job division, and, when the job division is set to be processed by using a cloud functionality processed in a cloud environment which does not include the information processing system, cause the cloud environment to process the job division.

### BRIEF DESCRIPTION OF THE DRAWINGS

Exemplary embodiment of the present disclosure will be described in detail based on the following figures, wherein:

FIG. 1 is a schematic view of an exemplary hardware configuration of an image forming system according to an exemplary embodiment;

FIG. 2 is a block diagram illustrating an exemplary hardware configuration of a cloud apparatus according to an exemplary embodiment;

FIG. 3 is a block diagram illustrating an exemplary hardware configuration of an image forming apparatus according to an exemplary embodiment;

FIG. 4 is a block diagram illustrating an exemplary hardware configuration of an information processing apparatus according to an exemplary embodiment;

FIGS. 5A and 5B are flowcharts of exemplary information processing performed by an information processing apparatus according to an exemplary embodiment; and

FIG. 6 is a flowchart of exemplary cloud processing performed by a cloud apparatus according to an exemplary embodiment.

### DETAILED DESCRIPTION

An exemplary embodiment of the present disclosure will be described below by referring to the drawings. Identical or equivalent components or parts are designated with identical reference numerals in the drawings. The dimensional ratios in the drawings may be exaggerated for convenience of description, and may be different from actual ratios.

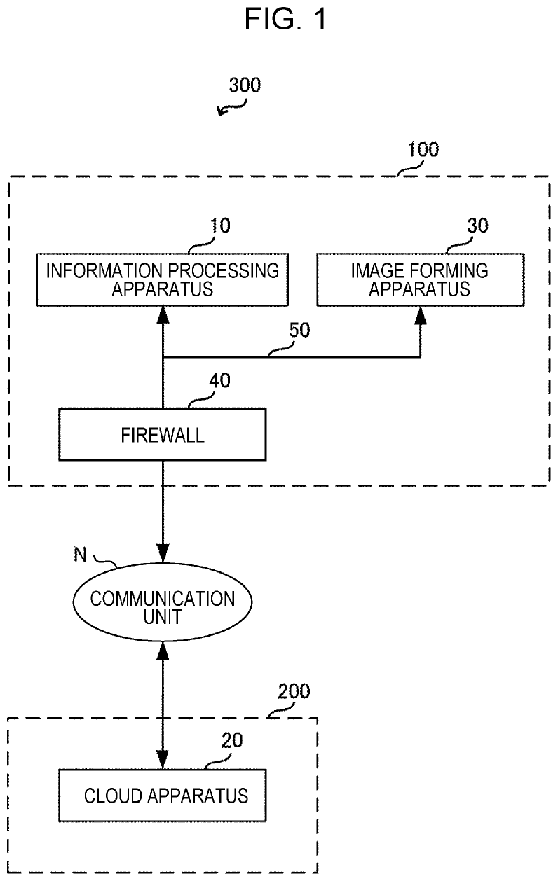

FIG. 1 is a diagram illustrating an exemplary configuration of an image forming system 300 according to an exemplary embodiment. In the image forming system 300 according to the present exemplary embodiment, a local environment 100 and a cloud environment 200 are connected to a communication unit N.

The local environment 100, which is a closed network system within the local environment 100, may provide services in response to internal accesses. The local environment 100 is a network environment which is operated and used by an organization, such as a company or a business establishment.

The local environment 100 includes an information processing apparatus 10, an image forming apparatus 30, and a firewall 40. The information processing apparatus 10 and the image forming apparatus 30 are connected to a local area network 50 such as a local area network (LAN) so as to be capable of communicating with each other.

The example in FIG. 1 illustrates a single information processing apparatus 10 and a single image forming apparatus 30. Alternatively, the local environment 100 may have any configuration as long as the local environment 100 includes one or more information processing apparatuses 10 and one or more image forming apparatuses 30. In addition, in the image forming system 300, the image forming apparatus 30 may have the functional configuration of the information processing apparatus 10. In this case, the local environment 100 may have any configuration as long as the local environment 100 includes the image forming apparatus 30 and the firewall 40.

The cloud environment 200 is a network environment including a network cloud. A network cloud is a network group that includes multiple computers connected to each other over a network and that serves as a black box, whose inside is hidden from the outside, to provide only inputs/outputs. The cloud environment 200 may provide services in response to accesses from the outside.

The cloud environment 200 includes a cloud apparatus 20. In other words, the cloud environment 200 does not include an information processing apparatus 10. The example in FIG. 1 illustrates a single cloud apparatus 20. The cloud environment 200 may have any configuration as long as the cloud environment 200 includes one or more cloud apparatuses 20.

For example, the cloud apparatus 20 has a function of providing services or the like in which the image forming apparatus 30 in the local environment 100 is used as an output apparatus. That is, the services which are capable of being provided by the information processing apparatus 10 and the image forming apparatus 30 in the local environment 100 may be provided also by the cloud apparatus 20 and the image forming apparatus 30.

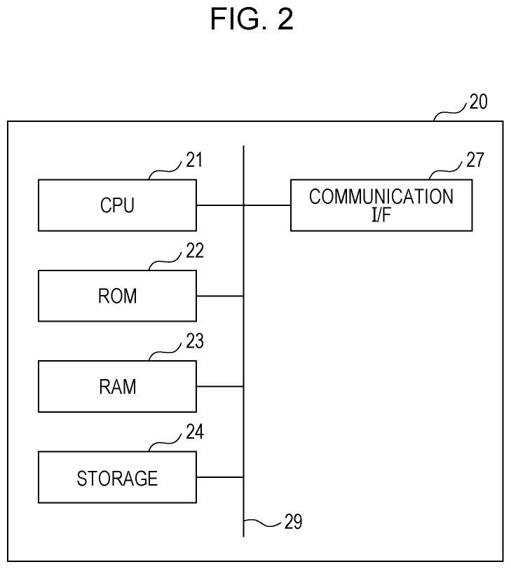

As illustrated in FIG. 2, the cloud apparatus 20 has the configurations of a central processing unit (CPU) 21, a read only memory (ROM) 22, a random access memory (RAM) 23, a storage 24, and a communication interface (I/F) 27. The configurations are communicatively connected to each other through a bus 29.

The CPU 21, which is a central processing unit, executes various programs and controls the units. That is, the CPU 21 reads programs from the ROM 22 or the storage 24, and executes the programs by using the RAM 23 as a work area. According to programs recorded in the ROM 22 or the storage 24, the CPU 21 controls the configurations and performs various computations. In the present exemplary embodiment, the ROM 22 or the storage 24 stores cloud programs.

The ROM 22 stores various programs and various data. The RAM 23 serves as a work area which temporarily stores programs and data. The storage 24, which is formed of a hard disk drive (HDD) or a solid state drive (SSD), stores various programs, including an operating system, and various data. In addition, the storage 24 stores a setting database.

The communication I/F 27, which is an interface for communication with other apparatuses, uses standards, such as Ethernet™, fiber distributed data interface (FDDI), and Wi-Fi™.

The firewall 40 has a function of limiting accesses from the communication unit N to the local environment 100.

The image forming apparatus 30 is a multifunction device in which two or more functions, for example, among image reading, image printing, image copying, and image transmission, are implemented in a single housing. However, the configuration is not limited to this example. For example, an apparatus, in which one of these functions is implemented, may be used, or an apparatus, in which these functions are not implemented, may be used.

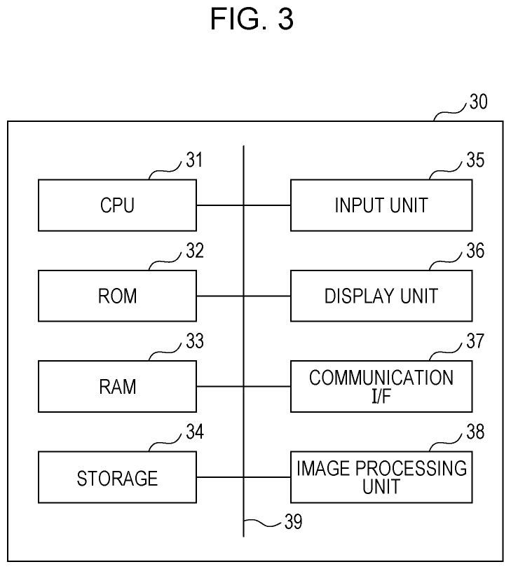

As illustrated in FIG. 3, the image forming apparatus 30 has the configurations of a CPU 31, a ROM 32, a RAM 33, a storage 34, an input unit 35, a display unit 36, a communication I/F 37, and an image processing unit 38. The configurations are communicatively connected to each other through a bus 39. In addition, the image forming apparatus 30 may include an image reading unit which reads image data and an image forming unit which forms an image from image data on a sheet serving as a recording medium.

The CPU 31, which is a central processing unit, executes various programs and controls the units. That is, the CPU 31 reads programs from the ROM 32 or the storage 34 and executes the programs by using the RAM 33 as a work area. According to programs recorded in the ROM 32 or the storage 34, the CPU 31 controls the configurations and performs various computations.

The ROM 32 stores various programs and various data. The RAM 33 serves as a work area which temporarily stores programs and data. The storage 34, which is formed of an HDD or an SSD, stores various programs, including an operating system, and various data.

The input unit 35, which includes a pointing device such as a mouse and a keyboard, is used for various inputs. The display unit 36, which is, for example, a liquid-crystal display, displays various types of information. The display unit 36 may employ a touch panel system and may function as the input unit 35.

The communication I/F 37, which is an interface for communication with other apparatuses, uses standards, such as Ethernet™, FDDI, and Wi-Fi™.

The image processing unit 38 performs image processing.

The information processing apparatus 10 is an exemplary information processing system. “System” according to the present exemplary embodiment encompasses both a system including multiple apparatuses and a system including a single apparatus.

For example, the information processing apparatus 10 has a function of providing services in which the image forming apparatus 30 is used as an output apparatus. Examples of such services in which the image forming apparatus 30 is used as an output apparatus include image reading, image printing, image copying, and image transmission.

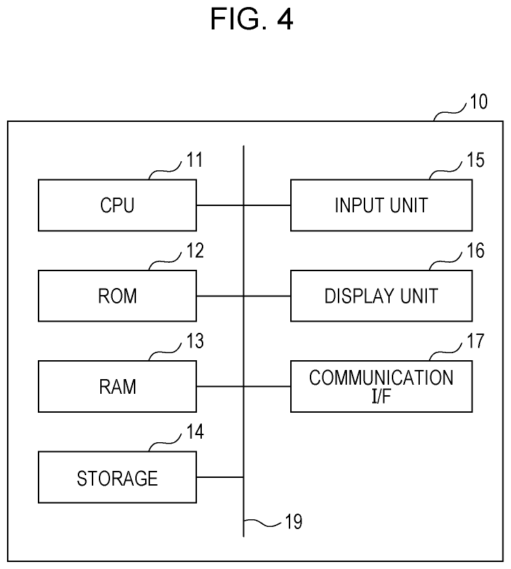

As illustrated in FIG. 4, the information processing apparatus 10 has the configurations of a CPU 11, a ROM 12, a RAM 13, a storage 14, an input unit 15, a display unit 16, and a communication I/F 17. The configurations are communicatively connected to each other through a bus 19.

The CPU 11, which is a central processing unit, executes various programs and controls the units. That is, the CPU 11 reads programs from the ROM 12 or the storage 14 and executes the programs by using the RAM 13 as a work area. According to programs recorded in the ROM 12 or the storage 14, the CPU 11 controls the configurations and performs various computations. In the present exemplary embodiment, the ROM 12 or the storage 14 stores an information processing program.

The ROM 12 stores various programs and various data. The RAM 13 serves as a work area which temporarily stores programs and data. The storage 14, which is formed of an HDD or an SSD, stores various programs, including an operating system, and various data. The storage 14 stores a setting database.

The input unit 15, which includes a pointing device such as a mouse and a keyboard, is used for various inputs. The display unit 16, which is, for example, a liquid-crystal display, displays various types of information. The display unit 16 may employ a touch panel system and may function as the input unit 15.

The communication I/F 17, which is an interface for communication with other apparatuses, uses standards, such as Ethernet™, FDDI, and Wi-Fi™.

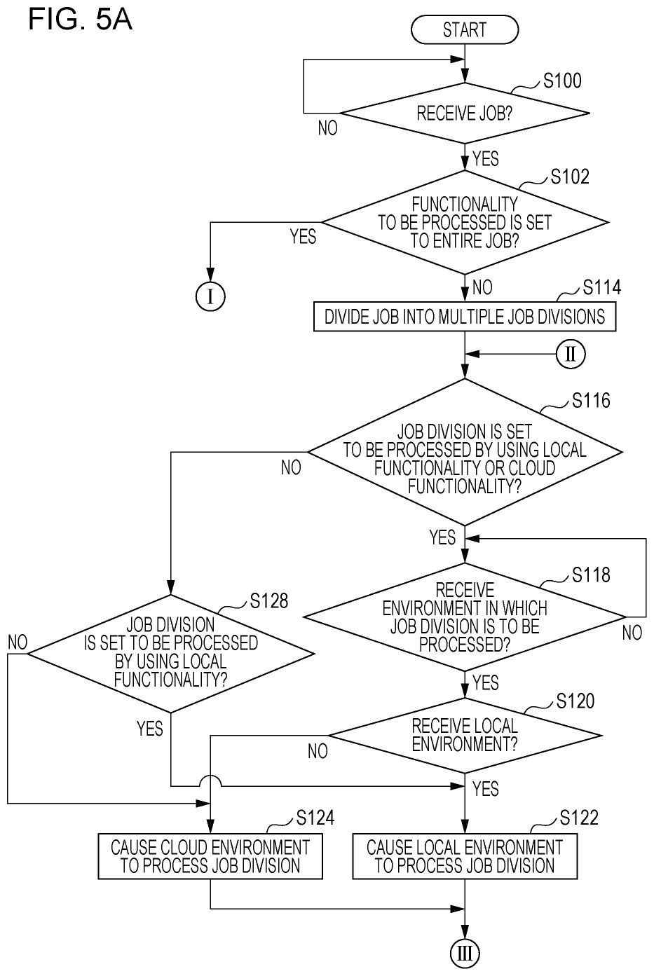

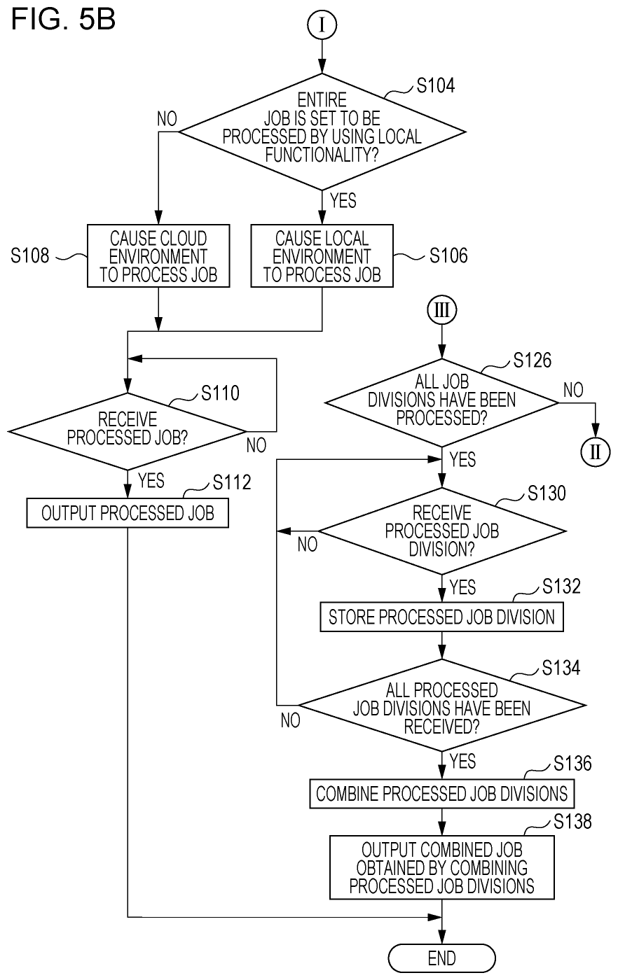

Referring to FIGS. 5A and 5B, the flow of information processing performed by the information processing apparatus 10 according to the present exemplary embodiment will be described. The information processing is performed by the CPU 11 which reads the information processing program from the ROM 12 or the storage 14 and which loads the information processing program on the RAM 13 for execution.

In the present exemplary embodiment, the case in which a functionality to be processed is predetermined for the entire job or each job division, which is obtained by dividing the job, by using the input unit 15 or a user terminal (for example, a personal computer or a smartphone) owned by a user who uses the information processing apparatus 10 will be described.

In step S100 in FIG. 5A, the CPU 11 waits until a job is received. Specifically, the CPU 11 waits until a job is received, for example, from the input unit 15 of the information processing apparatus 10 or a user terminal. If the CPU 11 receives a job (YES in step S100), the CPU 11 proceeds to step S102. Hereinafter, a job received by the CPU 11 in step S100 is simply referred to as a “job”.

In step S102, the CPU 11 determines whether a functionality to be processed is set to the entire job. If a functionality to be processed is set to the entire job (YES in step S102), the CPU 11 proceeds to step S104.

In step S104, the CPU 11 determines whether the entire job is set to be processed by using a local functionality performed in the local environment 100. If the entire job is set to be processed by using a local functionality (YES in step S104), the CPU 11 proceeds to step S106. In contrast, if the entire job is not set to be processed by using a local functionality, in other words, if the entire job is set to be processed by using a cloud functionality performed in the cloud environment 200 (NO in step S104), the CPU 11 proceeds to step S108.

In the present exemplary embodiment, for example, a function of adjusting the color of a job described in Printer Job Language (PJL) commands or binary data, a setting for outputting a sheet of the envelope size, or screen adjustment is used as a local function. For example, a function of performing character recognition and masking a specific string or a function which enables image printing after acknowledgement from a third party is used as a cloud function. However, the configuration is not limited to this example. For example, a functionality having a higher security level than cloud functionality or a functionality which requires a longer time than cloud functionality may be used as a local functionality.

In step S106, the CPU 11 causes the local environment 100 to process the job. The CPU 11 may cause the information processing apparatus 10 to process the job. Specifically, the CPU 11 causes the local environment 100 to perform the local functionality which is set to the entire job. Then, the CPU 11 proceeds to step S110.

In step S108, the CPU 11 causes the cloud environment 200 to process the job. Specifically, the CPU 11 transmits the job to the cloud apparatus 20. Then, the CPU 11 proceeds to step S110.

In step S110, the CPU 11 waits until a processed job which is the job having processed in the local environment 100 or the cloud environment 200 is received. If the CPU 11 receives the processed job (YES in step S110), the CPU 11 proceeds to step S112.

In step S112. the CPU 11 outputs the processed job. Then, the information processing ends. In the present exemplary embodiment, the CPU 11 outputs the processed job to the image forming apparatus 30. However, the configuration is not limited to this example. For example, the CPU 11 may output the processed job, for example, to the display unit 16 of the information processing apparatus 10.

Back to step S102, if a functionality to be processed is not set to the entire job (NO in step S102), the CPU 11 proceeds to step S114.

In step S114, the CPU 11 divides the job into multiple job divisions. In the present exemplary embodiment, the CPU 11 divides the job on a page-by-page basis. However, the configuration is not limited to this example. For example, the CPU 11 may divide the job in a pages-by-pages basis. When the job is constituted by multiple jobs, the job may be divided into the individual jobs.

In step S116, the CPU 11 determines whether a job division is set to be processed by using a local functionality or a cloud functionality. If the job division is set to be processed by using a local functionality or a cloud functionality (YES in step S116), the CPU 11 proceeds to step S118.

In step S118, the CPU 11 waits until an environment, among the local environment and the cloud environment, in which the job division is to be processed is received. In the present exemplary embodiment, the CPU 11 receives an environment, among the local environment and the cloud environment, in which the job division is to be processed. If the CPU 11 receives an environment in which the job division is to be processed (YES in step S118), the CPU 11 proceeds to step S120. The CPU 11 may present, for example, to a display unit, information (for example, the page number) for identifying the job division, which is set to be processed by using a local functionality or a cloud functionality, and their specific functions.

In step S120, the CPU 11 determines whether the local environment is received in step S118. If the CPU 11 receives the local environment in step S118 (YES in step S120), the CPU 11 proceeds to step S122. In contrast, if the CPU 11 receives the cloud environment in step S118 (NO in step S120), the CPU 11 proceeds to step S124.

In step S122, the CPU 11 causes the local environment 100 to process the job division. The CPU 11 may process the job division by using the information processing apparatus 10. Specifically, the CPU 11 causes the local environment 100 to perform the local functionality which is set to the job division. Then, the CPU 11 proceeds to step S126.

In step S124, the CPU 11 causes the cloud environment 200 to process the job division. Specifically, the CPU 11 transmits the job division to the cloud apparatus 20. Then, the CPU 11 proceeds to step S126.

In step S126, the CPU 11 determines whether all the job divisions of the job have been processed in either the local environment or the cloud environment. If all the job divisions of the job have been processed in either the local environment or the cloud environment (YES in step S126), the CPU 11 proceeds to step S130. In contrast, if all the job divisions of the job have not been processed in either the local environment or the cloud environment (NO in step S126), the CPU 11 goes back to step S116.

Back to step S116, if the job division is not set to be processed by using a local functionality or a cloud functionality, in other words, if the job division is set to be processed by using either a local functionality or a cloud functionality (NO in step S116), the CPU 11 proceeds to step S128.

In step S128, the CPU 11 determines whether the job division is set to be processed by using a local functionality. If the job division is set to be processed by using a local functionality (YES in step S128), the CPU 11 proceeds to step S122. In contrast, if the job division is not set to be processed by using a local functionality, in other words, if the job division is set to be processed by using a cloud functionality (NO in step S128), the CPU 11 proceeds to step S124.

In step S130, the CPU 11 waits until a processed job division which is a job division having processed in the local environment 100 or the cloud environment 200 is received. If the CPU 11 receives a processed job division (YES in step S130), the CPU 11 proceeds to step S132.

In step S132, the CPU 11 stores, in the storage 14, the processed job division received in step S130. The CPU 11 may store, in a storage device outside the information processing apparatus 10, the processed job division received in step S130.

In step S134, the CPU 11 determines whether all the processed job divisions of the job have been received. If the CPU 11 has received all the processed job divisions of the job (YES in step S134), the CPU 11 proceeds to step S136. In contrast, if the CPU 11 has not received all the processed job divisions of the job (NO in step S134), the CPU 11 goes back to step S130.

In step S136, the CPU 11 combines, with each other, all the processed job divisions stored in the storage 14.

In step S138, the CPU 11 outputs the combined job obtained by combining the processed job divisions in step S136. Then, the information processing ends. In the present exemplary embodiment, the CPU 11 outputs the combined job of processed job divisions to the image forming apparatus 30. However, the configuration is not limited to this example. For example, the CPU 11 may output the combined job of processed job divisions, for example, to the display unit 16 of the information processing apparatus 10.

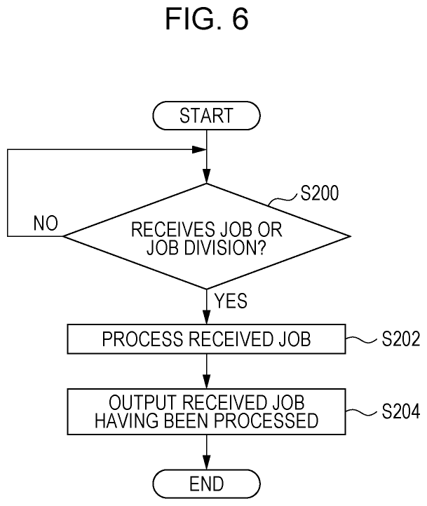

Referring to FIG. 6, the flow of cloud processing performed by the cloud apparatus 20 according to the present exemplary embodiment will be described. The cloud processing is performed by the CPU 21 which reads a cloud processing program from the ROM 22 or the storage 24 and which loads the program on the RAM 23 for execution.

In step S200 in FIG. 6, the CPU 21 waits until a job or a job division is received from the information processing apparatus 10. If the CPU 21 receives a job or a job division from the information processing apparatus 10 (YES in step S200), the CPU 21 proceeds to step S202.

In step S202, the CPU 21 processes the received job, which is a job or a job division, received in step S200. Specifically, the CPU 21 performs a cloud functionality which is set to the received job.

In step S204, the CPU 21 outputs, to the information processing apparatus 10, the received job having been processed in step S202. Then, the cloud processing ends.

The exemplary embodiment is described above. However, the technical scope of the present disclosure is not limited to the scope described in the exemplary embodiment. Various changes and improvements may be added to the exemplary embodiment without departing from the gist of the present disclosure. Embodiment obtained by adding the changes or improvements is also encompassed in the technical scope of the present disclosure.

The exemplary embodiment does not limit the claims. Not all the combinations of features described in the exemplary embodiment are necessary for the present disclosure which addresses disadvantages. Various stages of disclosure are included in the exemplary embodiment described above. Various disclosures are extracted through combinations of multiple disclosed components. Even when some components are removed from all the components described in the exemplary embodiment, the configuration in which some components are removed may be extracted as the present disclosure as long as the effects are obtained.

For example, in the exemplary embodiment, the information processing apparatus 10 which is a single apparatus performs the information processing. However, the configuration is not limited to this example. For example, multiple apparatuses may perform the information processing.

In the exemplary embodiment, if a job division is set to be processed by using a local functionality or a cloud functionality, the CPU 11 causes either the local environment or the cloud environment to process the job division. However, the configuration is not limited to this example. For example, in this case, after the CPU 11 causes the local environment to process the job division, the CPU 11 may cause the cloud environment to process the job division. Alternatively, after the CPU 11 causes the cloud environment to process the job division, the CPU 11 may cause the local environment to process the job division.

In the exemplary embodiment, if a job division is set to be processed by using a local functionality or a cloud functionality, the CPU 11 causes a received environment to process the job division. However, the configuration is not limited to this example. For example, in this case, the CPU 11 may cause an environment, which is designated by a user or a manager in advance, to process the job division.

In the exemplary embodiment, the CPU 11 combines, for output, all the processed job divisions of a job. However, the configuration is not limited to this example. The CPU 11 may combine, for output, some of the processed job divisions of a job.

In the exemplary embodiment, if a functionality to be processed is not set to the entire job, the CPU 11 divides the job into job divisions. However, the configuration is not limited to this example. Regardless of whether a functionality to be processed is set to the entire job, the CPU 11 may divide the job into job divisions.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiments, the form in which the programs are installed in a ROM or a storage is described. However, the configuration is not limited to this. The programs according to the exemplary embodiments may be provided in the form in which the programs are recorded in a computer-readable storage medium. For example, the programs according to the exemplary embodiments may be provided in the form in which the programs are recorded in an optical disk, such as a compact disc (CD)-ROM or a digital versatile disc (DVD)-ROM, or in the form in which the programs are recorded in a semiconductor memory, such as a Universal Serial Bus (USB) memory or a memory card. Alternatively, the programs according to the exemplary embodiments may be obtained from an external apparatus through a communication I/F.

In the exemplary embodiments, the case in which the processes performed by the information processing apparatus 10 and the cloud apparatus 20 are implemented with a software configuration through execution of programs using a computer is described. However, the present disclosure is not limited to this. For example, the processes performed by the information processing apparatus 10 and the cloud apparatus 20 may be implemented with a hardware configuration or a combination of a hardware configuration and a software configuration.

In addition, the configurations of the information processing apparatus 10, the cloud apparatus 20, and the image forming apparatus 30, which are described in the exemplary embodiments, are exemplary. Needless to say, unnecessary parts may be deleted or new parts may be added without departing from the gist of the present disclosure.

The flows of processes performed by the information processing apparatus 10 and the cloud apparatus 20, which are described in the exemplary embodiments, are also exemplary. Needless to say, unnecessary steps may be deleted, new steps may be added, and the processing order may be replaced without departing from the gist of the present disclosure.

### APPENDIX

(((1)))

An information processing system comprising:
a processor configured to:
   receive a job;
   divide the job into a plurality of job divisions; and
   for each job division, when the job division is set to be processed by using a local functionality processed in a local environment including the information processing system, cause the local environment to process the job division, and, when the job division is set to be processed by using a cloud functionality processed in a cloud environment which does not include the information processing system, cause the cloud environment to process the job division.
      (((2)))

The information processing system according to (((1))),
wherein the processor is configured to:
   when the job division is set to be processed by using the local functionality or the cloud functionality, cause either the local environment or the cloud environment to process the job division.
      (((3)))

The information processing system according to (((2))),
wherein the processor is configured to:
   receive an environment among the local environment and the cloud environment, the received environment being an environment in which the job division is to be processed; and
   on reception of the local environment, cause the local environment to process the job division, and, on reception of the cloud environment, cause the cloud environment to process the job division.
      (((4)))

The information processing system according to any one of (((1))) to (((3))),
wherein the processor is configured to:
   receive processed job divisions which are the job divisions each having been processed in the local environment or the cloud environment; and
   combine, for output, the processed job divisions of the job.
      (((5)))

The information processing system according to any one of (((1))) to (((4))),
wherein the processor is configured to:
   when a functionality to be processed is not set to the entire job, divide the job into the job divisions, and, when a functionality to be processed is set to the entire job, not divide the job into the job divisions.
      (((6)))

The information processing system according to (((5))),
wherein the processor is configured to:
   when the entire job is set to be processed by using the local functionality, cause the local environment to process the job, and, when the entire job is set to be processed by using the cloud functionality, cause the cloud environment to process the job.
      (((7)))

An information processing program causing a computer to execute a process comprising:
receiving a job;
dividing the job into a plurality of job divisions; and
for each job division, when the job division is set to be processed by using a local functionality processed in a local environment including an information processing system, causing the local environment to process the job division, and, when the job division is set to be processed by using a cloud functionality processed in a cloud environment which does not include an information processing system, causing the cloud environment to process the job division.

What is claimed is:

1. An information processing system comprising:
a processor configured to:
receive a job;
divide the job into a plurality of job divisions; and
for each job division, when the job division is set to be processed by using a local functionality processed in a local environment including the information processing system, cause the local environment to process the job division, and, when the job division is set to be processed by using a cloud functionality processed in a cloud environment which does not include the information processing system, cause the cloud environment to process the job division.

2. The information processing system according to claim 1,
wherein the processor is configured to:
when the job division is set to be processed by using the local functionality or the cloud functionality, cause either the local environment or the cloud environment to process the job division.

3. The information processing system according to claim 2,
wherein the processor is configured to:
receive an environment among the local environment and the cloud environment, the received environment being an environment in which the job division is to be processed; and
on reception of the local environment, cause the local environment to process the job division, and, on reception of the cloud environment, cause the cloud environment to process the job division.

4. The information processing system according to claim 1,
wherein the processor is configured to:
receive processed job divisions which are the job divisions each having been processed in the local environment or the cloud environment; and
combine, for output, the processed job divisions of the job.

5. The information processing system according to claim 1,
wherein the processor is configured to:
when a functionality to be processed is not set to the entire job, divide the job into the job divisions, and, when a functionality to be processed is set to the entire job, not divide the job into the job divisions.

6. The information processing system according to claim 5,
wherein the processor is configured to:
when the entire job is set to be processed by using the local functionality, cause the local environment to process the job, and, when the entire job is set to be processed by using the cloud functionality, cause the cloud environment to process the job.

7. A non-transitory computer readable medium storing a program causing a computer to execute a process for information processing, the process comprising:
receiving a job;
dividing the job into a plurality of job divisions; and
for each job division, when the job division is set to be processed by using a local functionality processed in a local environment including an information processing system, causing the local environment to process the job division, and, when the job division is set to be processed by using a cloud functionality processed in a cloud environment which does not include an information processing system, causing the cloud environment to process the job division.

8. An information processing method comprising:
receiving a job;
dividing the job into a plurality of job divisions; and
for each job division, when the job division is set to be processed by using a local functionality processed in a local environment including an information processing system, causing the local environment to process the job division, and, when the job division is set to be processed by using a cloud functionality processed in a cloud environment which does not include an information processing system, causing the cloud environment to process the job division.
